(19) United States
(12) Patent Application Publication
(10) Pub. No.: US 2004/0237111 A1
(43) Pub. Date: Nov. 25, 2004

(54) Multimedia and entertainment system for an automobile

(76) Inventors: Spiro Iraclianos, Bloomington, IN (US); William Neal House, Greenwood, IN (US); Steven W Hutt, Bloomington, IN (US)

Correspondence Address: HARNESS, DICKEY & PIERCE, P.L.C., P.O. BOX 828, BLOOMFIELD HILLS, MI, 48303, US

(21) Appl. No.: 10/482,010

(22) PCT Filed: Jun. 25, 2002
(86) PCT No.: PCT/US02/20375

(30) Foreign Application Priority Data
Jun. 26, 2001 (US) 60301011
May 2, 2002 (US) 60380001

(51) Int. Cl. H04N 7/18

(52) U.S. Cl. 725/75; 725/77

(57) ABSTRACT

A multimedia and entertainment system for an automobile is disclosed to include a plurality of loudspeakers located and distributed throughout the interior passenger compartment of the automobile. Loudspeakers of the conventional cone-type as well as electro-dynamic planar loudspeakers may be incorporated into the present invention. At least one loudspeaker is operably integrated within the passenger compartment of an automobile and is located in the proximity of a video display of the system. The electronic audio signal that serves the loudspeaker is processed in the audio system of the multimedia and entertainment system to optimize its full features and capabilities, including multi-audio-channel effects, so as to enable the passengers to completely experience the multimedia and entertainment system.

### FIELD OF THE INVENTION

The present invention relates to a multimedia and entertainment system for an automobile. More particularly, the present invention relates to a multimedia and entertainment system integrated into an automobile that includes a plurality of loudspeakers, including electro-dynamic planar loudspeakers. At least one loudspeaker can be located in the proximity of a video display for producing an audible output associated with a video source.

### BACKGROUND OF THE INVENTION

Integrated and sophisticated automobile audio systems, have long been a popular vehicle option to consumers. Automobile audio products and systems have created and supported a long-term and steady growth in the audio market for both automotive original equipment manufacturers and for the consumer automotive audio aftermarket.

In recent years, as advancements in electronics technologies have made it feasible, the popularity of automotive audio systems has expanded toward the combination of audio and video entertainment systems for automobiles. Today, automobile manufacturers can include such options on new vehicles.

These entertainment systems incorporate video display screens that operate together with the vehicle's audio system. However, known audio and video entertainment systems are effectively “add on” accessories, and not optimized to take advantage of the full capabilities of the automobile's audio system. These systems typically include additional loudspeakers for use by, though not particularly associated with or dedicated to, the video system. These loudspeakers are then utilized to recreate the entire audio spectrum that is associated with the video information. In addition, the electronic audio signals driving these loudspeakers are not processed to optimize the features of the audio system, such as the multi-channel effects of surround sound, which is an extremely desirable feature in a multimedia and entertainment system application.

Known automobile audio and video entertainment systems, with multi-channel surround sound, typically employ a front center speaker, which is located on the dashboard at the front of the vehicle's passenger compartment. The center channel speaker may process specific center channel information (usually dialogue or vocals) to create audio imaging characteristics that are localized in the front center of the vehicle between the front left and right loudspeakers. However, the audio information that is associated with the video system and is sent to this center channel speaker on the dashboard does not provide a realistic and localizable audio image that associates with the video for the rear seat passenger(s), who are viewing video display screens that are located directly in front of their seats. If the center channel audio output instead emanates from approximately the same physical location as the video monitor or better, from the video monitor screen itself, there is improved realism for the passenger by better associating the audio and video events.

In addition, advancements in the performance capabilities and manufacturing feasibility of electro-dynamic planar loudspeakers has made it possible to incorporate multiple such loudspeakers throughout an automobile and in locations heretofore unavailable to automobile audio system designers. This is due to both the small space-claim that is necessary for electro-dynamic planar loudspeakers and the broad performance characteristics that may be achieved with new electro-dynamic planar loudspeaker designs.

Therefore, it is an object of the present invention to provide a multimedia and entertainment system for an automobile that is optimized to incorporate the features and capabilities of the vehicle's audio and other systems, to enable all passengers to fully experience the system's multimedia and/or entertainment effects.

### SUMMARY OF THE INVENTION

Accordingly, the present invention provides a multimedia and entertainment system for an automobile that is including an audio source for generating an electronic audio signal, an audio system for processing the electronic audio signal and creating an audible output, a video source for generating an electronic video signal, and a video display device. At least a portion of the audio signal can be associated with the video signal.

The audio system includes a plurality of loudspeakers located and distributed throughout the interior passenger compartment of the automobile. Loudspeakers of the conventional cone-type as well as electro-dynamic planar loudspeakers may be incorporated into the present invention. With respect to the incorporation of electro-dynamic planar loudspeakers, such loudspeakers can be positioned in numerous locations throughout the automobile that have previously been unavailable to conventional loudspeakers.

At least one loudspeaker can be located in proximity to the video display. The portion of the electronic audio signal that is provided to the loudspeaker is processed through the audio system to optimize the full features and capabilities of the system, including its multi-channel effects, to enable the passengers to completely experience the multimedia and entertainment system.

Consequently, the present invention optimizes the audio signal associated with the video display and enhances the realism of the multimedia and entertainment experience to passengers in the automobile. The present invention can be used in a variety of automobile information and entertainment applications, including the viewing of motion pictures or other video programming playing from a digital video disc, videocassette recorder/player, or the like, that are integrated into the system; viewing television programming received through an integrated TV receiver; the playing of computer and/or video games on an integrated personal computer, a Nintendo® entertainment system, a Sony® PlayStation®, or the like; or the viewing of multimedia presentations running over the world-wide web or on software programs like Microsoft® Powerpoint® that are, in turn, running on an integrated PC.

In addition, other features may be integrated into the multimedia and entertainment system of the present invention, including a navigation system and communications systems.

It is contemplated that the present invention can be incorporated into a variety of multimedia and entertainment applications for transportation platforms outside of the automotive industry, including aircraft, trains, watercraft, and mass transit.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a representative schematic overview of one embodiment of a multimedia and entertainment system and its individual components comprising the features and advantages of the present invention;

FIG. 2 is a schematic block diagram representing a portion of the audio and video systems and components of the multimedia and entertainment system of FIG. 1;

FIG. 3 is a representative schematic overview of another embodiment of a multimedia and entertainment system of the present invention and its individual components;

FIG. 4 is a schematic block diagram representing a portion of the audio and video systems and components of the multimedia and entertainment system of FIG. 3;

FIG. 5 is a view from the rear toward the front of the passenger compartment of an automobile incorporating the multimedia and entertainment system of FIGS. 3 and 4;

FIG. 6 is a view from the rear toward the front of the passenger compartment of an automobile incorporating another embodiment of the multimedia and entertainment system;

FIG. 7 is a perspective view showing the front of a video display assembly operably located in the passenger compartment of an automobile incorporating the multimedia and entertainment system of FIGS. 3 and 4;

FIG. 8 is another perspective view showing the front of the video display assembly of FIG. 7;

FIG. 9 is a perspective view showing the rear of the video display assembly of FIG. 7;

FIG. 10 is another perspective view showing the rear of the video display assembly of FIG. 7;

FIG. 11 is a perspective view showing the front of an alternative embodiment of a video display assembly operably integrated into the passenger compartment of an automobile incorporating the multimedia and entertainment system of the present invention;

FIG. 12 is another perspective view showing the front of the video display and the loudspeaker of FIG. 11; and

FIG. 13 is an enlarged perspective view showing a close-up of the loudspeaker shown in FIG. 11;

FIG. 14 is a perspective view showing the front of still another alternative embodiment of a video display assembly operably integrated into the passenger compartment of an automobile incorporating the multimedia and entertainment system of the present invention;

FIG. 15 is a perspective view of an electro-dynamic planar loudspeaker which may be incorporated into the multimedia and entertainment system of the present invention;

FIG. 16 is an exploded perspective view of the electro-dynamic planar loudspeaker shown in FIG. 15;

FIG. 17 is a cross-sectional view taken along line 16-16 of FIG. 15; and

FIG. 18 is a detailed cross-sectional view of the encircled area of FIG. 17

### DETAILED DESCRIPTION OF THE PREFERRED EMBODIMENTS

The following description of the preferred embodiment(s) is merely exemplary in nature and is in no way intended to limit the invention, its application, or uses.

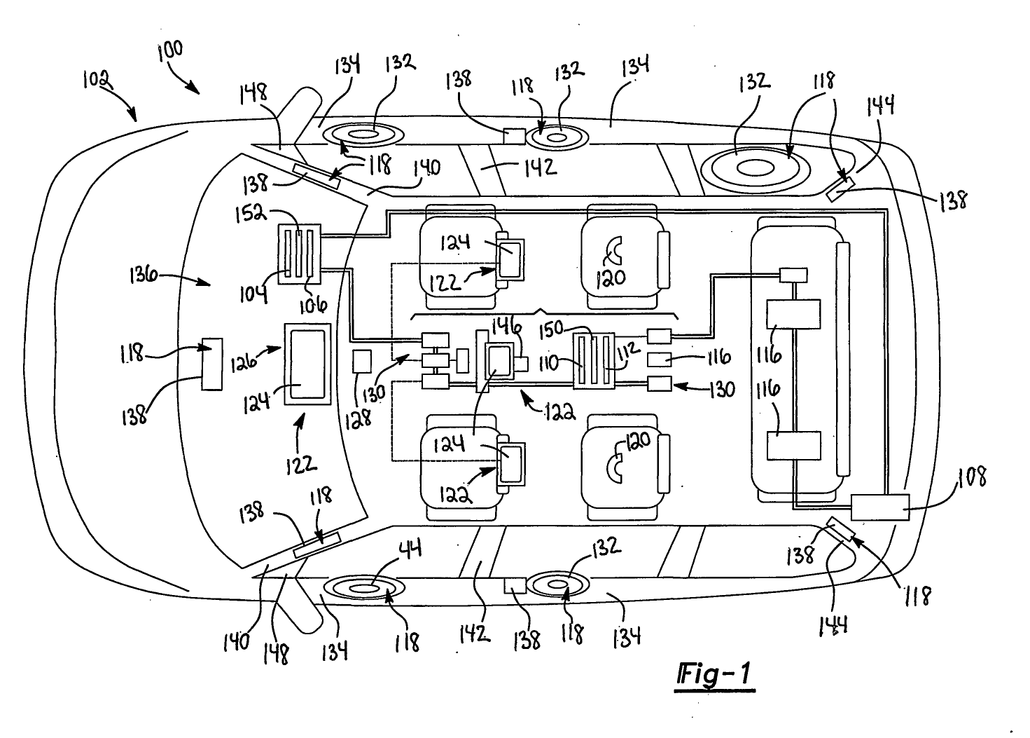

Referring now to the drawings, the multimedia and entertainment system 100 of the present invention is shown in a representative schematic overview in FIGS. 1-4. As shown in FIG. 1, the multimedia and entertainment system 100 of the present invention employs an audio system 200, video system 400 and related components (discussed and described in detail below) that are operably integrated together into the multimedia and entertainment system 100 of the automobile 102. For example, FIG. 1 shows the multimedia and entertainment system 100 to include audio and video components 200 and 400 like compact disc (CD) players 104, an MP3 player 106, and a radio tuner/receiver 22, a video cassette player/recorder 23 and a digital video disc (DVD) player 24, for example. An audio and video processing system 26, including a digital audio/video processor 28, a plurality of digital signal processor (DSP) power amplifiers 30, a plurality of loudspeakers 32, and headphones 34, is shown. One or more video display assemblies 36 are located to enable the passengers to view video screens 38 from their regular seating positions.

A navigation system 40 is shown and may also be integrated into the system of the present invention. A personal computer 25 may be included and integrated into the system, as may other devices, like well-known video entertainment devices such as, Nintendo®, Play Station® and others. A user I/O interface 42, which may include main and auxiliary components of any of a variety of well-known I/O devices, including video displays having touch screen controls, is included to enable the vehicle passengers to configure an control the operation of all of the components of the multimedia and entertainment system 10.

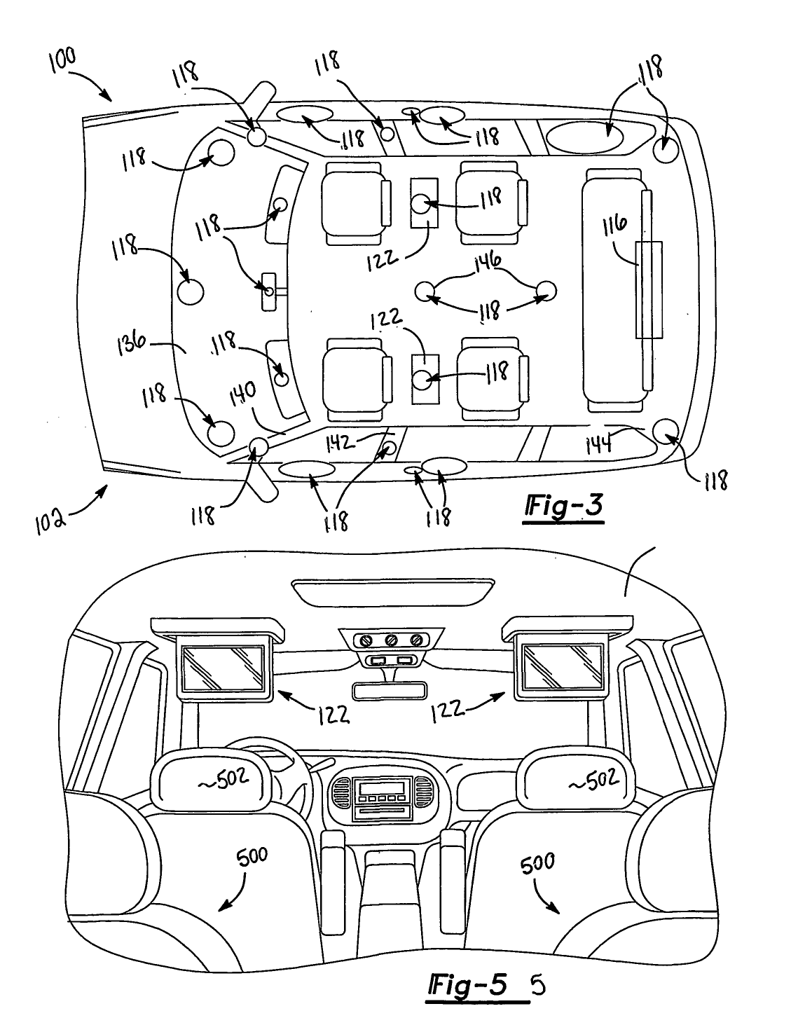

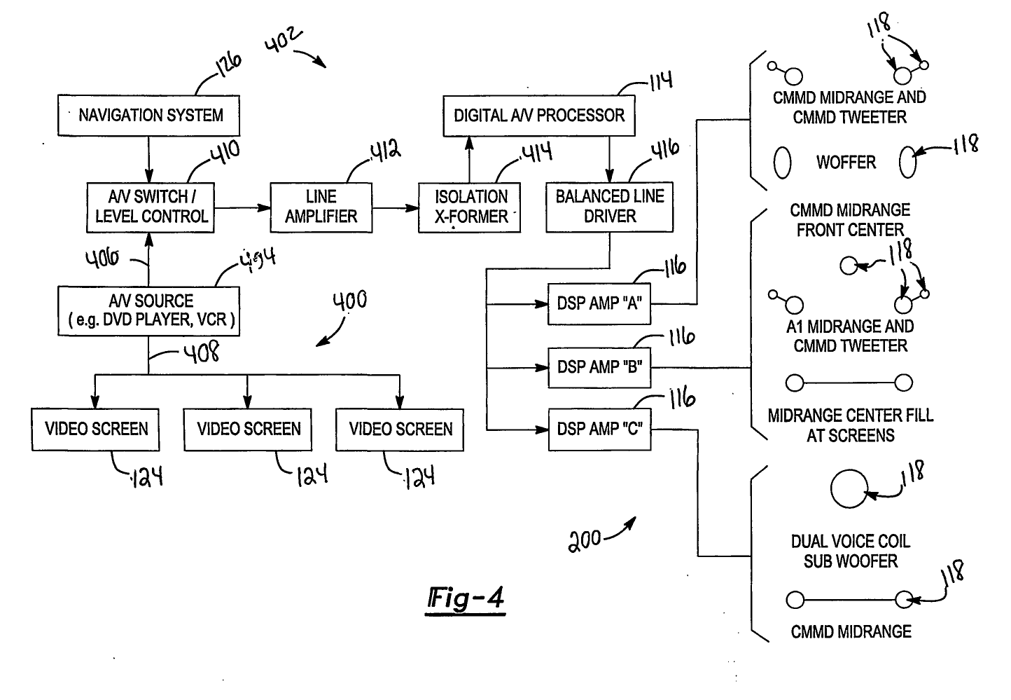

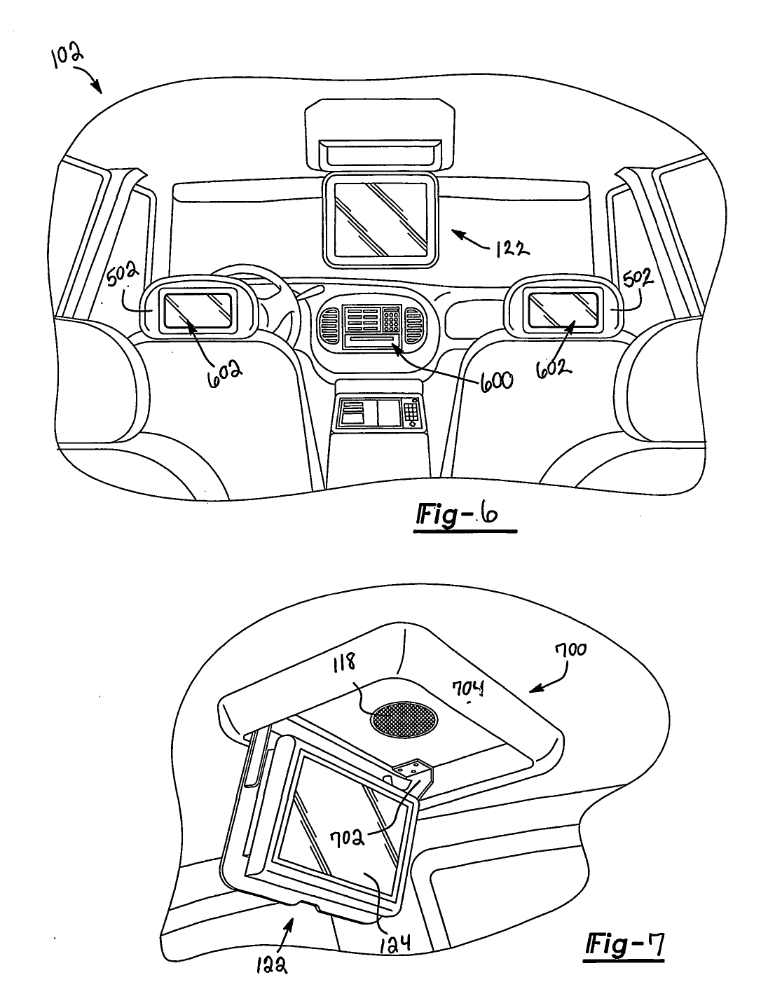

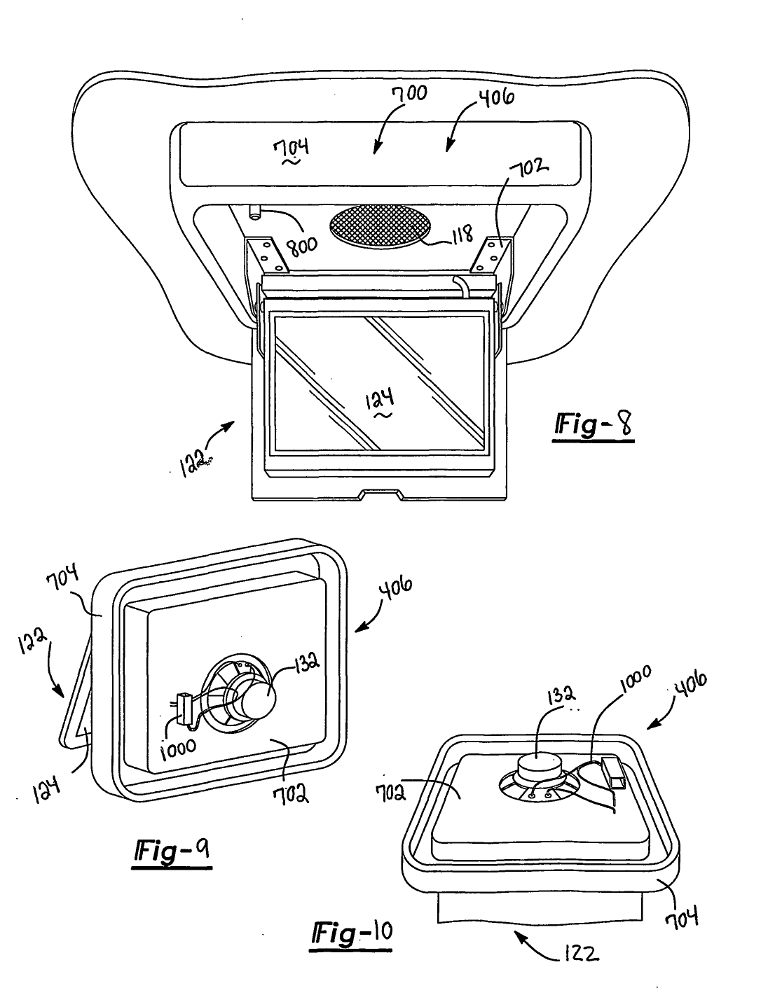

FIGS. 1 and 3 show examples for the placement of loudspeakers 32 within the multimedia and entertainment system 10 of the present invention. As illustrated, there are a multiplicity of loudspeakers 32 of different sizes and types that are located throughout the passenger compartment of the automobile 16 and driven by the audio system 12 and/or the video system 14 of the multimedia and entertainment system 10 of the present invention. For example, conventional cone-type loudspeakers 44 may be located in the door panels 46, in the dashboard 48, the kick panels, and the rear package shelf of the vehicle's interior. In addition and/or alternatively, electro-dynamic planar loudspeakers 50 can be incorporated throughout the vehicle as just described, and further at locations such as in the vehicle's body pillars, such as the A pillars 52, B pillars 53 and D pillars 55, in overhead mountings 57 in the vehicle's headliner, in the side view mirror sail panels 49, in the visors, in the passenger seats and/or headrests, and on the rearview mirror. Also, speakers 32 are specifically located in the proximity of video display assemblies 36. The variety and placement of the loudspeakers 32 in the system allows the system to immerse the passengers in the multimedia and entertainment being experienced through the system 10.

As mentioned above, electro-dynamic planar loudspeakers 50 can be incorporated in the present invention and throughout the vehicle. Referring to FIGS. 14-17, one particular electro-dynamic planar loudspeaker that may be incorporated for use in the present invention is identified at reference numeral 110. Electro-dynamic planar loudspeaker, hereinafter referred to as loudspeaker 110, includes a frame 112, a plurality of high-energy-density magnets 114 and a diaphragm 116. Frame 112 provides a structure for fixing magnets 114 in a predetermined relationship to one another. In the embodiment depicted, magnets 114 are positioned to define five rows of magnets with each row having three magnets. As best viewed in the cross-sectional views of FIGS. 16 and 17, the rows of magnets are arranged such that the adjacent rows of magnets have alternating polarity and the each magnets magnetic energy is concentrated in the gaps between the rows of magnets. Once the magnetic fields have been defined, diaphragm 1504 is fixed to the edge of frame 1502 along the diaphragm's periphery.

Diaphragm 1504 includes a thin film 1800 having a first side 1802 and a second side 1804. First side 1802 is coupled to frame 1502. Preferably, an adhesive 1806 which is curable by exposure to light (e.g., visible light) secures the film to the frame. To provide a movable membrane capable of producing sound, diaphragm 1504 is mounted to the frame in a state of tension and is spaced apart from magnets 1600 by a predetermined distance. The magnitude of tension under which the diaphragm is placed is dependent upon the loudspeaker's 1500 physical dimensions, the particular materials used to construct the diaphragm 1504 and the energy density of the magnetic field, or magnetic flux density, that is generated by magnets 1600. Preferably, magnets 1600 are constructed from a material capable of being magnetically charged to a high energy density, such as neodymium iron boron (NdFeB). Film 1800 is preferably made from polyethylenenaphthalate (PEN), which may be obtained in sheet-form. Film 1800 has a thickness of approximately 0.001 inches. In addition, other polymer materials available in sheet-form, such as polyester or Mylar™, polyamide or Kapton™, and polycarbonate or Lexan™ may also be suitable for making film 1800.

A conductor 1506 is attached to second side 1804 of film 1800. Preferably, conductor 1506 is comprising an aluminum foil that is securely bonded to film 1800. Conductor 1506 has a first end 1508 and a second end 1510 that are positioned adjacent to one another at one end of the film 1800. Conductor 1506 is traced in a serpentine fashion on diaphragm 1504 and has a plurality of substantially linear traces 1312 that are longitudinally extending along the film 1800. Linear traces 1512 are interconnected to one another by adjacently located radial traces 1314 to thereby join conductor 1506 into a single current path. Due to the serpentine fashion in which the conductor 1506 is traced onto the diaphragm 1504, some linear traces 1512 carry current flowing in a first direction 1516 and some linear traces 1512 carry current flowing in a second direction 1518, opposite that of first direction 1516.

The diaphragm 1504 is attached to the frame 1502 so that the linear traces 1512 are positioned within the magnetic fields that are generated by permanent magnets 1600. The linear sections 1512 carrying current flowing in a first direction 1516 are positioned within the magnetic fields having a similar directional polarization. Linear sections 1512 carrying current flowing in a second direction 1518 are placed within magnetic fields having an opposite directional polarization. Positioning the conductor 1506 linear traces 1512 in this manner assures that an electromotive driving force is generated by the interaction between the magnetic fields developed by magnets 1600 and the induced magnetic field(s) developed by current flowing through conductor 1506. As such, an electrical input signal traveling through conductor 1506 is converted to mechanical motion of diaphragm 1504, thereby producing an acoustical output.

Frame 1502 is a generally dish-shaped member preferably constructed from a substantially planar contiguous sheet steel. Frame 1502 includes a base plate 1602 surrounded by a wall 1700 extending generally orthogonally therefrom. Wall 1700 terminates at a radially extending flange 1702 which defines a substantially planar mounting surface 1808 on which diaphragm 1504 may be attached to frame 1502. A lip 1704 downwardly extends from flange 1702 in direction substantially parallel to wall 1700. Base plate 1602 includes a first surface 1810, a second surface 1812 and a plurality of apertures 1706 extending therethrough. Apertures 1706 are positioned and sized to provide the desired passageways for air positioned between first side 1802 of diaphragm 102 and first surface 1810 of frame 1502 to flow. As best shown in FIG. 16, frame 1502 includes apertures 1604 and 1606 extending through flange 1702 to provide clearance and mounting provisions for a conductor assembly 1608.

Conductor assembly 1608 includes a terminal board 1610, a first terminal 1612 and a second terminal 1614. Terminal board 1610 includes a mounting aperture 1616 and is preferably constructed from an electrically insulating material such as fiberglass. A pair of wires (not shown) pass through apertures 1604 to electrically couple first terminal 1612 to first end 1508 and second terminal 1614 to second end 1510. A fastener 1618 extends through apertures 1616 and 1606 to couple conductor assembly 1608 to frame 1502.

A grille 1620 functions to protect diaphragm 1504 from contact with objects inside the listening environment while also providing a method for mounting loudspeaker 1500. Grille 1620 includes a substantially planar body 1622 having a plurality of apertures 1624 extending therethrough. A rim 1626 extends substantially orthogonally from body 1622 along its perimeter. In the embodiment shown, rim 1626 engages frame 1502 to couple grille 1620 thereto.

An acoustical dampener 1628 is mounted to second surface 1812 of frame base plate 1602. Dampener 1628 serves to dissipate acoustical energy generated by diaphragm 1504 thereby minimizing undesirable amplitude peaks during operation.

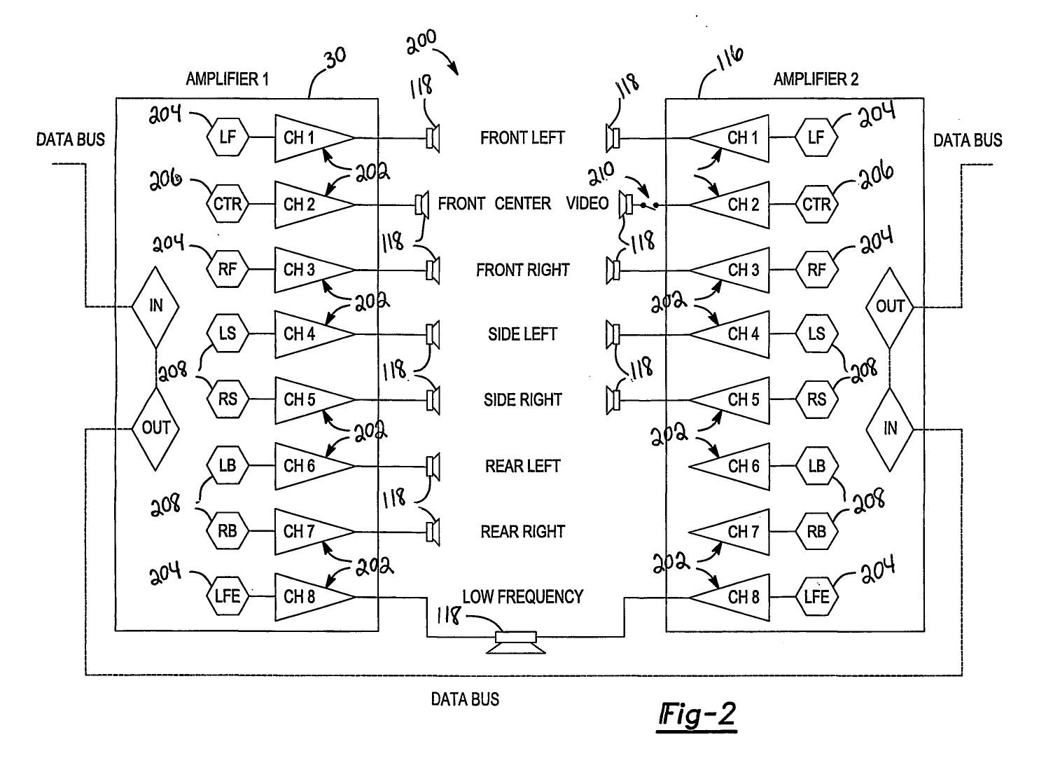

Turning now to FIGS. 2 and 4, schematic diagrams representing the audio system 200, video system 400 and the audio and video processing system 402 for the multimedia and entertainment system 100 of the present invention are illustrated. The audio and video processing system 402 incorporates surround sound decoding algorithms to enhance the acoustic experience of the video by surrounding the vehicle passengers with precisely located sound fields and spatial cues. An important feature of the present invention is that it can place certain audible output, for example, dialogue from a video source component 404, at the location of the video display assembly 122 and still provide the realistic disbursement of other special effects sound signals throughout the vehicle passenger compartment. Thus, the system 100 is optimized and precisely locates, for the passenger experiencing the system 100, the audible output at the location of the intended sound sources. For example, in the system 100 of the present invention, dialogue appears to originate from the actors viewed on the video screen 124 of the video display assemblies 122.

In FIG. 4, the multimedia and entertainment system 100 is shown to and may generally include, a navigation system 126, an audio system 200, and a video system 400. The video system 400 can include an audio/video source component 404 (types of which have been previously discussed) and a digital audio/video processing system 402. The audio/video source component 404 of the system 100 is capable of producing an electronic signal output that is corresponding to an audio signal 406 and a video signal 408. The audio/video source component 404 may, but does not require to be, combined in a single electronic device. FIG. 1 shows known audio, video and audio/video devices that may comprise the audio/video source component 404 and may be suitable for use with the present invention are, for example, a digital video disc (DVD) player 112, a videocassette player/recorder (VCP/VCR) 110, a personal computer (PC) 128, a television receiver 150, a radio tuner/receiver 108, a compact disc player 104, a MP3 player 106, and a cassette tape player 152, among others.

An electronic signal output (electronic audio signal 406 and electronic video signal 408) is generated by the audio/video source component 404. The electronic video signal 408 is provided to the video display assemblies 122 of the system where it is converted to a visual output on the video display screens 124.

The electronic audio signal 406 is provided to the audio and video processing system 402 of the multimedia and entertainment system 100 of the invention. There, the audio signal 406 is processed, such as by A/V switch/level Control 410, line amplifier 412, and isolation transformer 414, and optimized to produce the audible effects, such as surround sound effects, to be experienced by the vehicle's passengers. The digital audio/video processor 114 separates the audio signal 406 and steers the portions of the signal, via balanced line driver 416, to the appropriate amplifiers 116 and loudspeakers 118 to create the audible effects in the listening environment.

As shown in FIG. 2, the audio system 200 may, for example, incorporate eight separate channels 202 to create the required soundfield to be experienced with the multimedia and entertainment system 100 of the present invention. In addition to the left, right and low frequency channels 204 (used in normal stereo), a center channel 206 and surround channel(s) 208 are also incorporated. The center channel 206 is used to distribute an audio signal 406 to loudspeakers 118 at the front and center of the passenger compartment. In addition, when the video displays 122 are in use, at least a portion of the audio signal 406 that is associated with the video signal 408 is distributed to a loudspeaker 118 that is located in proximity to the video display 122. When the video display 122 is not in use, the loudspeaker 118 may be disabled from operation.

FIGS. 5 and 6 show a view of the interior of an exemplary automobile 102 incorporating the multimedia and entertainment system 100 of the present invention. As is shown, a plurality of video display assemblies 122 are included and available to the passengers in the rear seat 500 of the vehicle. The video display assemblies 122 are operably integrated into the interior of the passenger compartment of the vehicle overhead and directly in front of the rear seat 500. FIG. 6 also shows another embodiment of an interior of an automobile 102 that incorporates a video display assembly 122 over the center console 600 and a video display assembly 602 integrated into the seat headrest 502.

Illustrated in FIGS. 7-10 is one embodiment of a video display assembly 122 for use with the present invention. The video display assembly 122 is operably integrated in an overhead configuration 700 into the passenger compartment of the automobile 102. Alternatively, the video display assembly 122 may be mounted within the vehicle in a seat back, armrest or other configuration. It is preferred that the video display screen 124 be of a thin film transistor (TFT) type or other similar type of flat panel display. Again, flat panel technology is preferred in order to keep the space claim within the vehicle's passenger compartment for the video display assembly 122, 602 to a minimum.

The video display screen 124 shown in FIGS. 7-10 is pivotally mounted to a mounting bracket 702 that attaches the video display assembly 122 within the vehicle's interior. The loudspeaker 118 is also attached to the mounting bracket 702. A trim piece or bezel 704 covers the mounting bracket 702 and provides for an aesthetically pleasing integration of the video display assembly 122 into the automobile's 102 interior. When not in use, the video display screen 124 is folded upward, out of the way, into and flush with the bezel 704. A connector 1000 that is suitable for wiring the video display screen 124 into the video system of the multimedia and entertainment system 100 of the present invention is included in the video display assembly 122.

A loudspeaker 118 is incorporated into the video display assembly 122 and is located in proximity to a video display screen 124. The loudspeaker 118 is driven by an electronic audio signal (input) processed and optimized through the audio system 200. The optimized audio signal that drives the loudspeaker 118 enables the loudspeaker 118 to place audible output corresponding with at least a portion of the electronic video signal at the location of the video display 122.

As best Illustrated in FIGS. 9 and 10, the loudspeaker 118 is shown to be a standard cone-type loudspeaker 132. However, an electro-dynamic planar loudspeaker 138, such as one already described herein, may be preferred in this application for its low profile, since it is desirable for the video display assembly 122 to be slim and occupy as little of the vehicle's interior space as possible, when not in use. A switch, such as a physical switch 800 or digital switch 210 (FIG. 2) may be included in the video display assembly 122 that automatically prohibits operation of the loudspeaker 118 when the video display screen 124 is stowed and/or not in use.

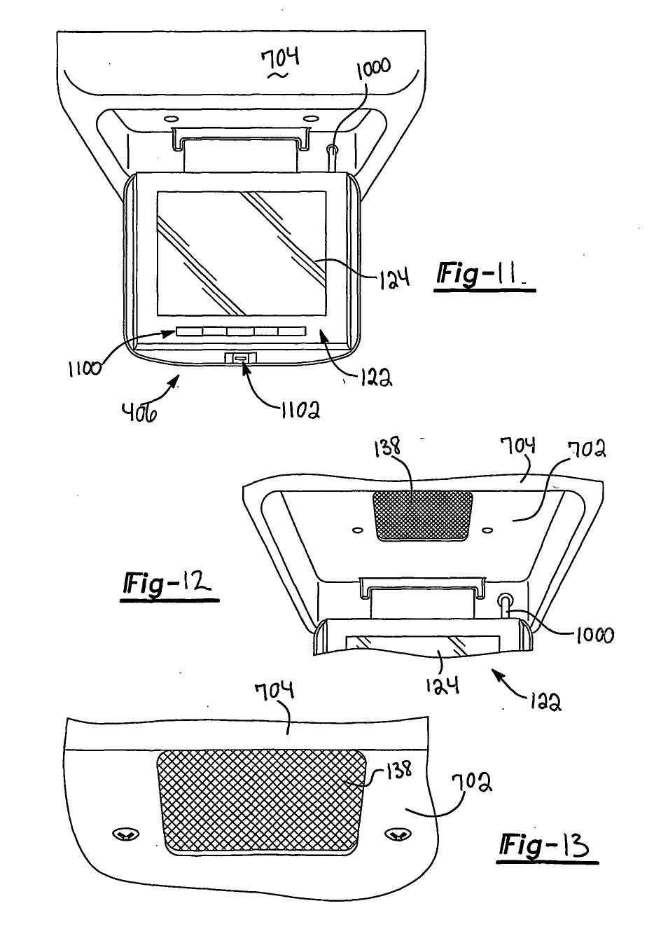

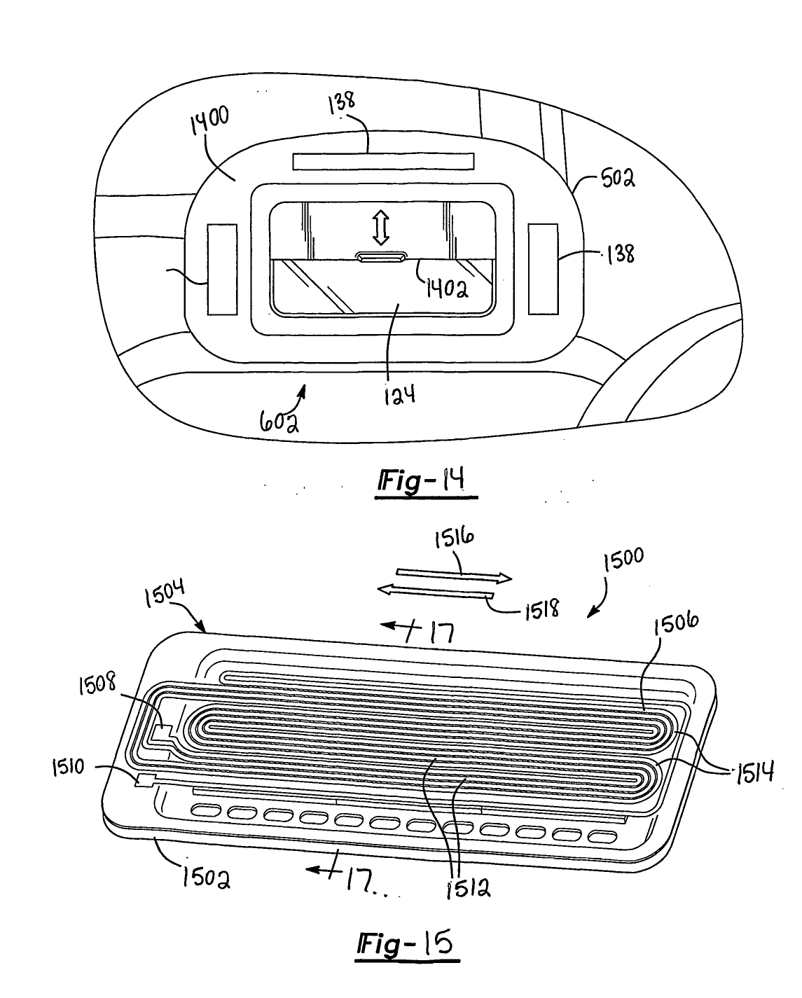

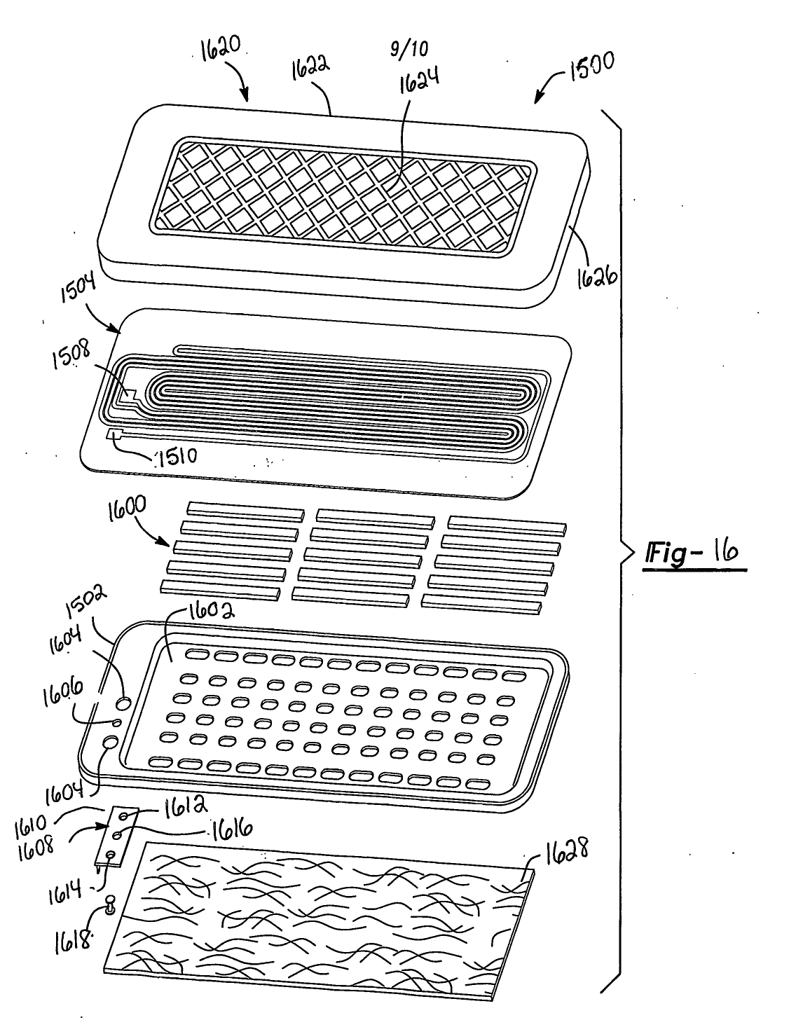

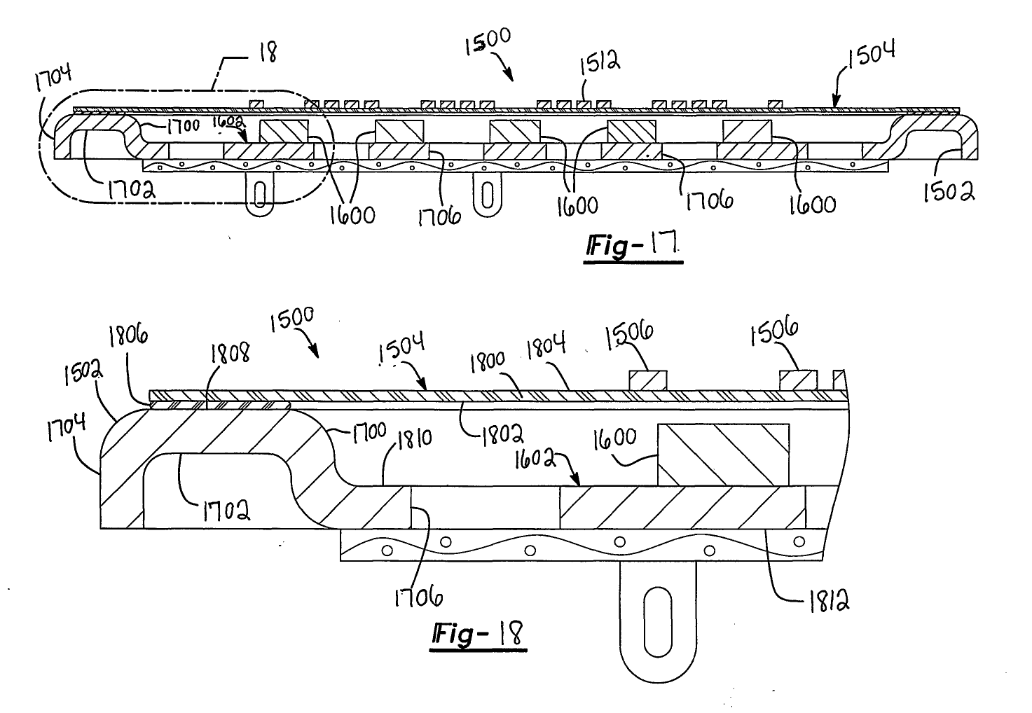

FIGS. 11, 12, and 13 show an alternative embodiment of a video display assembly 122 for use in the present invention. Again, the video display assembly 122 is mounted within the vehicle's interior in an overhead configuration by a mounting bracket 702. In this embodiment, an electro-dynamic planar loudspeaker 138, such as that previously described, is shown to be incorporated into the video display assembly 122.

Controls 1100 for the video display screen 124 may be included in the video display assembly 122, such as for the brightness, contrast and other display features of the video display screen 124. In addition, controls 1100 may also provide the user with the ability to select the source of the video signal that is to be displayed through the video display assembly, when multiple video sources are available in the multimedia and entertainment system 100. Controls 1100 may also provide the user with the ability to control the audio for the loudspeaker 138, such as the audio source, the volume, or to disable or mute the loudspeaker 138, and the like. The video display assembly also includes a latch 1102 which may also double as an cut-off switch that is operable to prohibit operation of the electro-dynamic planar loudspeaker 138 when the video display screen 124 is in a stowed and latched position.

The video display assemblies 122 may also incorporate mounting apparatus for the loudspeaker 118 that enables the loudspeaker 118 to be automatically or selectively aimed by the passenger(s) viewing the associated video display screen 124. For example, a pivotal mounting member may be included in the video display assemblies 122 that causes the loudspeaker 118 to pivot outward from the bezel 704 and toward the passenger, thereby directing the loudspeaker's 118 audible output in that same direction. Alternatively, a gimbaled mounting member may be included that would enable the passenger to direct the audible output of the loudspeaker 118 in the direction desired by or best suited to the passenger. In yet another embodiment, the audible output of the loudspeaker 118 may be reflected in a predetermined direction by a reflector that directs the audible output of the loudspeaker 118 in a predetermined manner or as desired by the passenger.

Referring to FIGS. 6 and 14, another video display assembly 602 is shown. This video display assembly 602 is adapted to be and is incorporated in the headrest 502 of the seats of the vehicle 102. The video display screen 124 is mounted within the headrest 502 so as to be flush with or slightly recessed to the exterior rear surface 1400 of the headrest 502. One or more electro-dynamic planar loudspeakers 138 are likewise mounted in the headrest 502, in a position adjacent to the video display screen 124. Alternatively, one or more loudspeakers 118 that are associated with the video display assembly 602 may be mounted in an overhead position relative to the vehicle's passengers that are viewing the video display assembly 602, within the headliner of the vehicle 102.

The video display assembly 602 may further incorporate a protective cover or shield 1402 that may be selectively deployed by the user to cover the video display screen 124. The shield 1402 can serve as a barrier to help protect the video display assembly 122 from incidental damage during the operational life of the vehicle. When the system 100 is in use, the user may slide the shield 1402 to a stowed position to reveal the video display screen 124. In addition to providing a protective covering for the video display assembly 602, or alternatively, the shield 1402 can serve as an anti-glare/anti-reflective covering that also may be selectively deployed over the video display screen 124 during operation of the multimedia and entertainment system 100 to eliminate or reduce glare or reflections on the video display screen 124 that negatively affect the user's viewing experience.

The foregoing description of the invention is merely exemplary in nature and, thus, variations that do not depart from the substance of the invention are intended to be within the scope of the invention. Such variations are not to be regarded as a departure from the spirit and scope of the invention.

What is claimed is:

1. A multimedia and entertainment system for an automobile, said multimedia and entertainment system comprising:
an audio source for generating an electronic audio signal;
an audio system for processing said electronic audio signal and creating an audible output corresponding to said electronic audio signal;
a video source for generating an electronic video signal;
at least one video display device for displaying a visual output corresponding to said electronic video signal, said at least one video display device being operably integrated into a passenger compartment of said automobile;
at least a portion of said electronic audio signal being associated with at least a portion of said electronic video signal;
said audio system comprising at least one loudspeaker operably integrated within said passenger compartment of said automobile, said at least one loudspeaker being located proximate to said video display device such that said at least one loudspeaker places at least a portion of said audible output that is corresponding to said at least a portion of said electronic audio signal at the location of said video display device.

2. The multimedia and entertainment system of claim 1, wherein said video display device includes a mounting member for mounting said video display device integrally within said passenger compartment of said automobile; and wherein
said at least one loudspeaker is connected to said mounting member.

3. The multimedia and entertainment system of claim 2, wherein said at least one loudspeaker comprises an electro-dynamic planar loudspeaker.

4. The multimedia and entertainment system of claim 2, wherein said at least one loudspeaker comprises a direct radiator-type loudspeaker.

5. The multimedia and entertainment system of claim 1, wherein said audio source, said audio system, and said video source are operably integrated into said automobile.

6. The multimedia and entertainment system of claim 1, further comprising:
a switch that disables the operation of said loudspeaker when said video display device is not in use.

7. The multimedia and entertainment system of claim 1, further comprising:
a reflector that reflects said at least a portion of said audible output in a predetermined direction.

8. The multimedia and entertainment system of claim 1, further comprising:
a collapsible reflector that reflects said at least a portion of said audible output in a predetermined direction.

9. The multimedia and entertainment system of claim 2, further comprising a pivotal member for connecting said loudspeaker to said mounting member which is operable to direct said at least a portion of said audible output in a predetermined direction.

10. The multimedia and entertainment system of claim 2, further comprising a gimbaled member for connecting said loudspeaker to said mounting member which is operable to alter the direction of said at least a portion of said audible output.

11. The multimedia and entertainment system of claim 1, wherein said audio source and said video source are comprised in a single device.

12. A video display assembly for use in a multimedia and entertainment system that is operably integrated into the interior passenger compartment of an automobile, said video display assembly comprising:
a video display screen for displaying a visual output;
at least one loudspeaker for producing an audible output; and
a mounting member, said at least one loudspeaker being connected to said mounting member; and wherein
said video display assembly is operably integrated within said interior passenger compartment of said automobile.

13. The video display assembly of claim 12, wherein said at least one loudspeaker comprises an electro-dynamic planar loudspeaker.

14. The video display assembly of claim 13, wherein said at least one loudspeaker comprises a direct radiator-type speaker.

15. The video display assembly of claim 12, further comprising:
a switch that disables the operation of said loudspeaker when said video display screen is not in use.

16. The video display assembly of claim 12, further comprising:
a reflector that reflects said audible output in a predetermined direction.

17. The video display assembly of claim 12, further comprising a pivotal member for connecting said loudspeaker to said mounting member, said pivotal member being operable to direct said audible output in a predetermined direction.

18. The video display assembly of claim 12, further comprising a gimbaled member for connecting said loudspeaker to said mounting member, said gimbaled member being operable to alter the direction of said audible output.

19. The video display assembly of claim 12 further comprising a protective shield that is selectively deployable to cover said video display screen.

20. The video display assembly of claim 19 wherein said protective shield provides an anti-glare cover for said video display screen.

21. A video display assembly comprising:
a TFT video display screen;
an electro-dynamic planar loudspeaker comprising a single frame member, a plurality of high-energy-density magnets positioned within said frame member, a diaphragm attached to said frame member in a state of tension, said diaphragm comprising a thin film and a conductor traced in a serpentine fashion on said film; and wherein
said video display assembly is permanently integrated within the interior passenger compartment of an automobile.

22. The video display assembly of claim 21 wherein said video display assembly is permanently integrated within a headrest of a passenger seat located within the interior passenger compartment of an automobile.

23. The video display assembly of claim 21 wherein said video display assembly is permanently integrated with a headliner of the interior passenger compartment of an automobile.

24. The video display assembly of claim 21 comprising a plurality of said electro-dynamic planar loudspeakers.

25. The video display assembly of claim 21 further comprising a protective shield that is selectively deployable to cover said video display screen.

26. The video display assembly of claim 25 wherein said protective shield provides an anti-glare cover for said video display screen.

27. The video display assembly of claim 21, further comprising:
a switch that disables the operation of said electro-dynamic planar loudspeaker when said video display screen is not in use.

28. The video display assembly of claim 21, further comprising:
a reflector that reflects an audible output from said electro-dynamic planar loudspeaker in a predetermined direction.

29. The video display assembly of claim 21, further comprising a mounting member, electro-dynamic planar loudspeaker being connected to said mounting member.

30. The video display assembly of claim 29, further comprising a pivotal member for connecting said electro-dynamic planar loudspeaker to said mounting member, said pivotal member being operable to direct said audible output in a predetermined direction.

31. The video display assembly of claim 29, further comprising a gimbaled member for connecting said loudspeaker to said mounting member, said gimbaled member being operable to alter the direction of said audible output.

32. A multimedia and entertainment system for an automobile, said multimedia and entertainment system comprising:
an audio source for generating an electronic audio signal;
an audio system for processing said electronic audio signal and creating an audible output corresponding to said electronic audio signal;
a video source for generating an electronic video signal;
at least one video display device for displaying a visual output corresponding to said electronic video signal, said at least one video display device being operably integrated into a passenger compartment of said automobile;
at least a portion of said electronic audio signal being associated with at least a portion of said electronic video signal;
said audio system comprising at least one electro-dynamic planar loudspeaker comprising a single frame member, a plurality of high-energy-density magnets positioned within said frame member, a diaphragm attached to said frame member in a state of tension, said diaphragm comprising a thin film and a conductor traced in a serpentine fashion on said film;
said at least one electro-dynamic planar loudspeaker being operably integrated within said passenger compartment of said automobile, said at least one electro-dynamic planar loudspeaker being located proximate to said video display device such that said at least one electro-dynamic planar loudspeaker places at least a portion of said audible output that is corresponding to said at least a portion of said electronic audio signal at the location of said video display device.

33. The multimedia and entertainment system of claim 32 further comprising at least one electro-dynamic planar loudspeaker operably integrated within a headliner located in said passenger compartment of said automobile.

34. The multimedia and entertainment system of claim 32 further comprising at least one electro-dynamic planar loudspeaker operably integrated within a headrest of a passenger seat located in said passenger compartment of said automobile.

35. The multimedia and entertainment system of claim 32 further comprising at least one electro-dynamic planar loudspeaker operably integrated within a side view mirror sail panel located in said passenger compartment of said automobile.

36. The multimedia and entertainment system of claim 32 further comprising at least one electro-dynamic planar loudspeaker operably integrated within a visor located in said passenger compartment of said automobile.

37. The multimedia and entertainment system of claim 32 further comprising at least one electro-dynamic planar loudspeaker operably integrated within a door panel located in said passenger compartment of said automobile.

38. The multimedia and entertainment system of claim 32 further comprising at least one electro-dynamic planar loudspeaker operably attached to a support pillar of said automobile.

39. The multimedia and entertainment system of claim 32 further comprising at least one electro-dynamic planar loudspeaker operably integrated within a kick panel located in said passenger compartment of said automobile.

40. The multimedia and entertainment system of claim 32 further comprising at least one electro-dynamic planar loudspeaker operably integrated within an instrument panel located in said passenger compartment of said automobile.

41. The multimedia and entertainment system of claim 32 further comprising at least one electro-dynamic planar loudspeaker operably integrated within a rear shelf located in said passenger compartment of said automobile.

42. The multimedia and entertainment system of claim 32 further comprising at least one electro-dynamic planar loudspeaker operably integrated within a rearview mirror located in said passenger compartment of said automobile.

43. An audio system for an automobile comprising:
an audio source for generating an electronic audio signal;
an audio system for processing said electronic audio signal and creating an audible output corresponding to said electronic audio signal;
said audio system comprising at least one electro-dynamic planar loudspeaker comprising a single frame member, a plurality of high-energy-density magnets positioned within said frame member, a diaphragm attached to said frame member in a state of tension, said diaphragm comprising a thin film and a conductor traced in a serpentine fashion on said film;
said at least one electro-dynamic planar loudspeaker being operably integrated within said passenger compartment of said automobile.

44. The multimedia and entertainment system of claim 43 wherein said at least one electro-dynamic planar loudspeaker is operably integrated within a headliner located in said passenger compartment of said automobile.

45. The multimedia and entertainment system of claim 43 wherein said at least one electro-dynamic planar loudspeaker is operably integrated within a headrest of a passenger seat located in said passenger compartment of said automobile.

46. The multimedia and entertainment system of claim 43 wherein said at least one electro-dynamic planar loudspeaker is operably integrated within a side view mirror sail panel located in said passenger compartment of said automobile.

47. The multimedia and entertainment system of claim 43 wherein said at least one electro-dynamic planar loudspeaker is operably integrated within a visor located in said passenger compartment of said automobile.

48. The multimedia and entertainment system of claim 43 wherein said at least one electro-dynamic planar loudspeaker is operably integrated within a door panel located in said passenger compartment of said automobile.

49. The multimedia and entertainment system of claim 43 wherein said at least one electro-dynamic planar loudspeaker is operably attached to a support pillar of said automobile.

50. The multimedia and entertainment system of claim 43 wherein said at least one electro-dynamic planar loudspeaker is operably integrated within a kick panel located in said passenger compartment of said automobile.

51. The multimedia and entertainment system of claim 43 wherein said at least one electro-dynamic planar loudspeaker is operably integrated within an instrument panel located in said passenger compartment of said automobile.

52. The multimedia and entertainment system of claim 43 wherein said at least one electro-dynamic planar loudspeaker is operably integrated within a rear shelf located in said passenger compartment of said automobile.

53. The multimedia and entertainment system of claim 43 wherein said at least one electro-dynamic planar loudspeaker is operably integrated within a rearview mirror located in said passenger compartment of said automobile.
